(19) United States
(12) Patent Application Publication
(10) Pub. No.: US 2008/0056170 A1
(43) Pub. Date: Mar. 6, 2008

(54) Reduced performance mode when receiving a common control channel

(75) Inventors: Petri Komulainen, Oulu (FI); Christopher Peter Callender, Hampshire (GB); Sari Nielsen, Espoo (FI); Jorma Kaikkonen, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/891,998

(22) Filed: Aug. 14, 2007

Related U.S. Application Data
(60) Provisional application No. 60/837,906, filed on Aug. 14, 2006.

(51) Int. Cl. G08C 17/00

(52) U.S. Cl. 370/311

(57) ABSTRACT

A common control channel is monitored with a first and a second receiver. A target quality is determined for that channel, which may be signaled from a network. A quality parameter for the channel is determined from the first and second receivers, and compared to the target quality (directly or indirectly). Responsive to the comparing, one of the receivers is then operated in a reduced performance mode which consumes less power, for which several examples are disclosed. The comparison for switching from full to reduced and back to full may use different thresholds, which may be dynamically adjusted autonomous of the network to maintain the target quality. The common control channel may be one with which a broadcast traffic channel is associated. Methods, apparatus and computer programs embodied on a memory are detailed.

### CROSS-REFERENCE TO RELATED U.S. PROVISIONAL PATENT APPLICATION

This application claims priority to Provisional U.S. Patent Application No. 60/837,906, filed on Aug. 14, 2006, the contents of which is hereby incorporated by reference in its entirety.

### TECHNICAL FIELD

The exemplary and non-limiting embodiments of this invention relate generally to wireless communications systems, devices, methods and computer program products, specifically for selectively depowering a mobile station's receiver(s) that receives a common channel without degrading QoS to the user on those common channels.

### BACKGROUND

Following are some acronyms used throughout the text below:
AICH: access indication channel
BLER: block error rate
CPICH: common pilot channel
DPCH: dedicated physical channel
E-UTRAN: evolved UTRAN (i.e. long term evolution of UTRAN or 3.9 G)
FACH: forward access channel
GSM: global system for mobile communications
MBMS: multimedia broadcast and multicast service
MCCH: MBMS control channel
MTCH: MBMS traffic channel
PCCPCH: primary common control physical channel
PCH: paging channel
PICH: paging indication channel
RACH: random access channel
RSCP: received signal code power
SCCPCH: secondary common control physical channel
SDU: service data unit (a higher layer protocol unit, e.g. a single Internet protocol IP packet)
SIR: signal to interference ratio
UE: user equipment
UTRAN: universal terrestrial radio access network
WCDMA: wideband code division multiple access

The third generation partnership project (3GPP) defines enhanced performance requirements for MBMS (multimedia broadcast and multicast), which under current specifications is sent using a WCDMA system, based on a diversity receiver reference architecture. Common channels in WCDMA include PCCPCH for the UE to receive system information, PICH for it to receive paging indications while it is in an idle mode, AICH for use in conjunction with RACH, and the SCCPCH which is used for a number of purposes including paging, FACH and providing MBMS services (MTCH, MCCH). Thus, the traffic channel MTCH carrying the substantive multimedia/multicast content is mapped to or otherwise associated with the control channel SCCPCH of the overall WCDMA architecture. Currently, specifications are under development for enhanced MBMS performance based on a reference receiver employing receive diversity.

Even without such specifications, manufacturers of UEs employ multiple approaches for conserving battery power so as to extend talk and standby time for their equipment. This is seen to be particularly important when receiving high-volume content such as multimedia/multicast or digital video over extended periods of time. This disclosure addresses those power saving concerns, and is particularly advantageous when used in conjunction with a WCDMA system over which MBMS or other common channel services are sent and received.

### SUMMARY

According to one exemplary embodiment of the invention is a method that includes monitoring a common channel with a first receiver and a second receiver, determining a target quality for the common control channel, measuring from the first and second receivers a quality parameter for the common control channel, and comparing the measured quality parameter to the target quality. Either the first or the second receiver is switched to a reduced performance mode of operation in response to the comparing.

According to another exemplary embodiment of the invention is an apparatus that includes a first receiver, a second receiver, and a processor. The first receiver is adapted to monitor a common channel. The second receiver is also adapted to monitor the common control channel. The processor is adapted to measure a quality parameter for the common control channel via the first and second receivers, and to compare the measured quality parameter to a target quality for the common control channel. Responsive to the comparing, either the first or the second receiver is adapted to switch to a reduced performance mode of operation.

According to yet another exemplary embodiment of the invention is a computer readable memory embodying a program of machine-readable instructions executable by a digital data processor to perform actions directed toward switching a receiver to a reduced performance mode of operation. In this embodiment, the actions include monitoring a common channel with a first receiver and a second receiver, determining a target quality for the common control channel, and measuring from the first and second receivers a quality parameter for the common control channel. The actions further include comparing the measured quality parameter to the target quality, and responsive to the comparing, switching either the first or the second receiver to a reduced performance mode of operation.

According to still another exemplary embodiment of the invention is an apparatus that includes first and second receiving means for receiving a common control channel, measuring means for determining from the first and second receiving means a quality parameter for the common control channel, and comparing means for comparing the measured quality parameter to a target quality for the common control channel. The first or the second receiving means is responsive to the comparing means to switch to a reduced performance mode of operation. In a particular embodiment, the first receiving means is a first wireless receiver, the second receiving means is a second wireless receiver, and the common control channel is one that is associated with a multimedia broadcast and multicast service traffic channel. In this particular embodiment the measuring means and the comparing means are embodied as a processor coupled to a memory.

### BRIEF DESCRIPTION OF THE DRAWINGS

Exemplary embodiments of the present invention are detailed below with reference to the following drawing figures.

FIG. 1 shows an exemplary environment in which embodiments of the invention may be practiced, with individual nodes shown with various relevant functional blocks

FIG. 2 is a block diagram of a user equipment similar to FIG. 1 but with additional detail.

FIG. 3 is a series of process steps for determining when to enter a reduced performance mode according to an embodiment of the invention.

FIG. 4 is a series of process steps for dynamically adjusting thresholds that may be used in FIG. 3 according to an embodiment of the invention.

### DETAILED DESCRIPTION

Related to MBMS, there has been interest in conserving power in a UE which has multiple receivers, by switching off one or more of its receive (RX)-diversity receivers when the UE operates under non-challenging radio propagation channel conditions. As a general principle it may be acceptable to do so (depending upon the implementation) because when the UE is receiving common channels (which are not power-controlled for specific users but broadcast to all users in the cell) its receiver performance does not have any impact to the overall WCDMA system performance. The same is not true for the case of dedicated channels where dedicated radio resources are allocated to the UE specifically. Additionally, related to common channels other than MBMS, a UE manufacturer may still choose to use receiver diversity, even though no enhanced performance requirement has been defined, based on a receive diversity reference receiver. Power saving opportunities are also of value in this scenario.

Below is described a method, apparatus and computer program embodied on a storage medium to opportunistically operate one (or more) of a UE's receivers in a reduced performance mode when receiving a common channel. The term reduced performance mode indicates a power-saving mode of the receiver, and includes depowering the entire receiver, depowering/deactivating one or more of the RAKE correlator fingers, or depowering/deactivating any number of other receiver components so that the receiver in the reduced performance mode consumes less power as compared to the receiver operating in its normal fully-operational mode. More particularly, embodiments of this invention manage that reduced performance mode so as to ensure that the quality of service on the common channel suffers no noticeable degradation to the user.

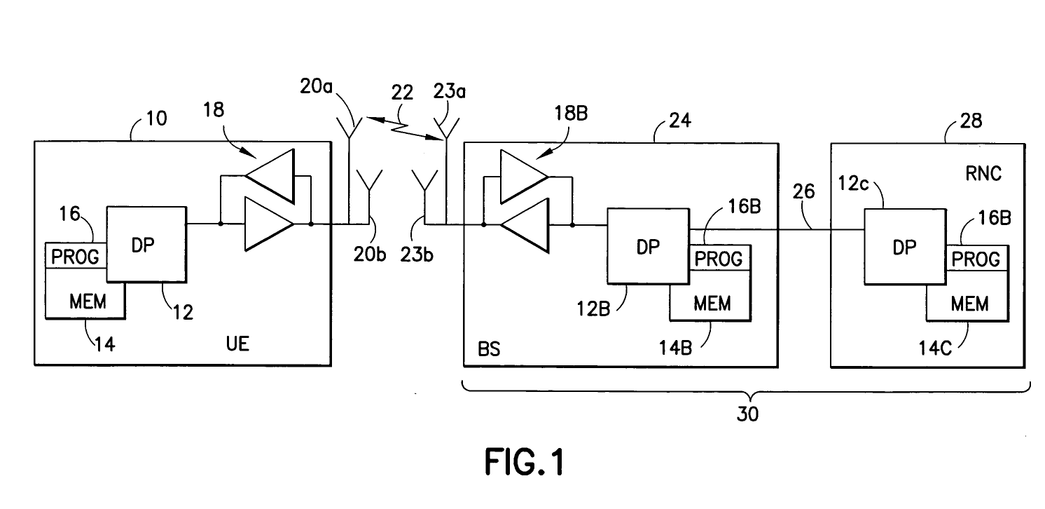

Reference is now made to FIG. 1 for illustrating a simplified block diagram of an exemplary environment for practicing the invention. An electronic device such as a UE 10, or any entity operating with similar functions as those described herein for a UE, includes a data processor (DP) 12, a memory 14 that stores a program 16, and a suitable radio frequency (RF) transceiver 18 and antennas 20a, 20b for bidirectional communications over a wireless link 22 with a antennas 23a, 23b of a BS 24. The BS 24 includes similar functional blocks as shown in FIG. 1 for the UE, denoted there with the suffix B. The BS 24 is under control of a radio node controller RNC 28 (alternatively termed a mobility management entity, a gateway, etc.), also with similar functional blocks numbered with the suffix C, and an Iu interface or other hardwire link 26 couples a modem (not shown) or other data input/output device of the BS 24 to a similar one in the RNC 28 for communications therebetween. Alternatively or additionally, the link 26 between the RNC and BS may be wireless without departing from the teachings herein. Generally, all nodes disposed upstream of the UE 10 are considered the network (except another destination UE not shown).

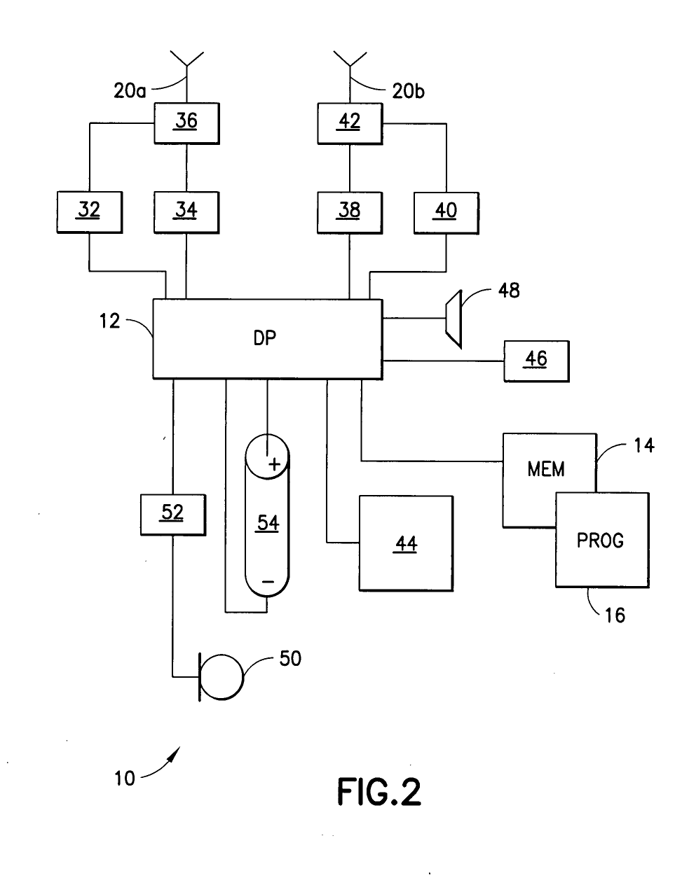

FIG. 2 illustrates in block diagram form further detail of the UE 10. The DP 12, memory 14 and program(s) 16 are as previously described. A first antenna 20a is coupled to a first transmitter 32 and a first receiver 34 through a first diplex filter 36. Similarly, a second antenna 20b is coupled to a second transmitter 38 and a second receiver 40 through a second diplex filter 42. Alternatives to the diplex filters are known, and the antenna may be one of several different types suitable for communications over the wireless channels such as dipole, monopole, PIFA, and the like. Each paired transmitter and receiver forms a transceiver, each coupled to the DP 12 and in an embodiment the two transceivers may be coupled to two antennas 20a, 20b to enable selective coupling of transceiver to antenna and/or to enable multiple input/multiple output (MIMO) communications as known in the art. While two transceivers are shown in FIG. 2, embodiments of the invention generally do not require a second transmitter 38. The UE 10 further includes a user interface 44 such as a keypad or a touch sensitive screen or a voice-recognition apparatus (e.g., microphone one and associated software); a graphical user interface 46 for displaying information to a user; a speaker 48 for audible output; a microphone 50 for audible input, and a buffer memory 52. The entire UE 10 is powered by a portable power source 54 such as a galvanic battery, which this invention seeks to reduce the consumption of power from. Various other components not shown are well known in the art and need not be detailed further; the illustrated components are relevant to the disclosed embodiments.

At least one of the programs 16 stored in the memory 14 is assumed to include program instructions that, when executed by the associated processor 12, enable the UE to operate in accordance with the exemplary embodiments of this invention, as will be discussed below in greater detail.

In general, the various embodiments of the UE 10 can include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the processor 12 of the UE 10, or by hardware, or by a combination of software and hardware. In some embodiments, signaling specific to the invention is sent from the BS 24 or the RNC 28 to the UE 10. For those embodiments, the appropriate software program 16B, 16C to effect that signaling is embodied in the respective memory 14B, 14C and executable by the DP 12B, 12C.

The memory 14 may be of any type suitable to the local technical environment and may be implemented using any suitable data storage technology, such as semiconductor-based memory devices, magnetic memory devices and systems, optical memory devices and systems, fixed memory and removable memory. The processor 12 may be of any type suitable to the local technical environment, and may include one or more of general purpose computers, special purpose computers, microprocessors, digital signal processors (DSPs) and processors based on a multi-core processor architecture, as non-limiting examples.

Respecting power conservation at the UE 10, one difficulty in arriving at a particular solution in WCDMA is determining in what circumstances it would be acceptable to consider entering a reduced performance mode. Different applications typically have different quality of service requirements (e.g. BLER or radio link control RLC SDU error rate) and the desired quality of service for a particular application is not generally known by the UE 10 Further, direct quality of service measurements can only be made rather slowly (e.g., typically, BLER measurement might take seconds or tens of seconds, since it is averaged over multiple blocks and infrequent transmissions will extend the averaging period). In a fading and dynamically changing mobile environment, the UE 10 might need to enter or leave a reduced performance mode quite rapidly in order to give significant power saving benefits while still not impacting the perceived performance of the UE 10, so waiting a few seconds for an accurate BLER measurement would tend to eliminate much of the potential power savings that might otherwise occur.

To this end the inventors introduce the concept of a target quality for reception of a common channel. The target quality may be signaled to the UE 10 from the network 30 (e.g., UTRAN, E-UTRAN, GSM) or may be derived by other means. The target quality concept is similar to the quality of service currently used for some dedicated channels in other wireless systems, but to the inventor's knowledge is not used on common channels. Broadly, when the UE 10 is receiving the common channels with better than the quality target, it may enter the reduced performance mode. In the reduced performance mode, the UE 10 is allowed to make any kind performance reductions provided that the performance still remains better than the signaled quality target. If the measured quality of the received common channel becomes worse than the signaled quality target, then the UE 10 should use all available means to receive the channel of interest to meet or exceed the quality target. Because the MTCH is associated with the SCCPCH, the MBMS content that a user views on the display 46 and/or hears over the speaker 48 arrives over a common control physical channel. A quality target enables the UE 10 to operate its receiver for the SCCPCH in a manner that uses less power than if it were continuously in full operational mode, yet the user's experience through the interfaces 46, 48 are not degraded in a noticeable manner. In embodiments where the quality target is sent from the network 30, some additional signaling may be required from the network 30 (e.g., UTRAN, E-UTRAN, GSM) to the UE 10 to enable that additional signaling (e.g., one or several additional bits to indicate target BLER, RLC SDU error rate target, etc.).

Two approaches are described for comparing a measured quality parameter against a quality target. Recall that in some instances, the quality parameter is of one type (e.g., BLER, typically a longer term average measure) and the measured parameter is of another type (e.g., signal to interference ratio (SIR), typically a short term measure). The measured quality parameter is compared against threshold, which may be the quality target or (in the case where they are of different type) a value representative of the quality parameter. As an example of different quality parameter types, BLER is a measure on blocks and is measured after decoding the transport blocks; SIR is a measure on bits and is measured after despreading the received signal. The RLC SDU error rate is measured at a processing level even before despreading. The threshold is selected so as to ensure the quality target is met. For clarity of explanation, the below description simply describes the quality parameter and the measured parameter, but the described target quality may be replaced by some value representative of the signaled/stored target quality so as to ensure comparison of parameters of like types (e.g., SIR to SIR). Thresholds are adapted to ensure that the quality target is met and the UE is appropriately switched between full and reduced operating modes when the measured quality parameter is compared against the threshold. In the description below, the measured quality parameter is denoted generically as Q, regardless of whether that measured quality parameter is BLER, SIR, etc.

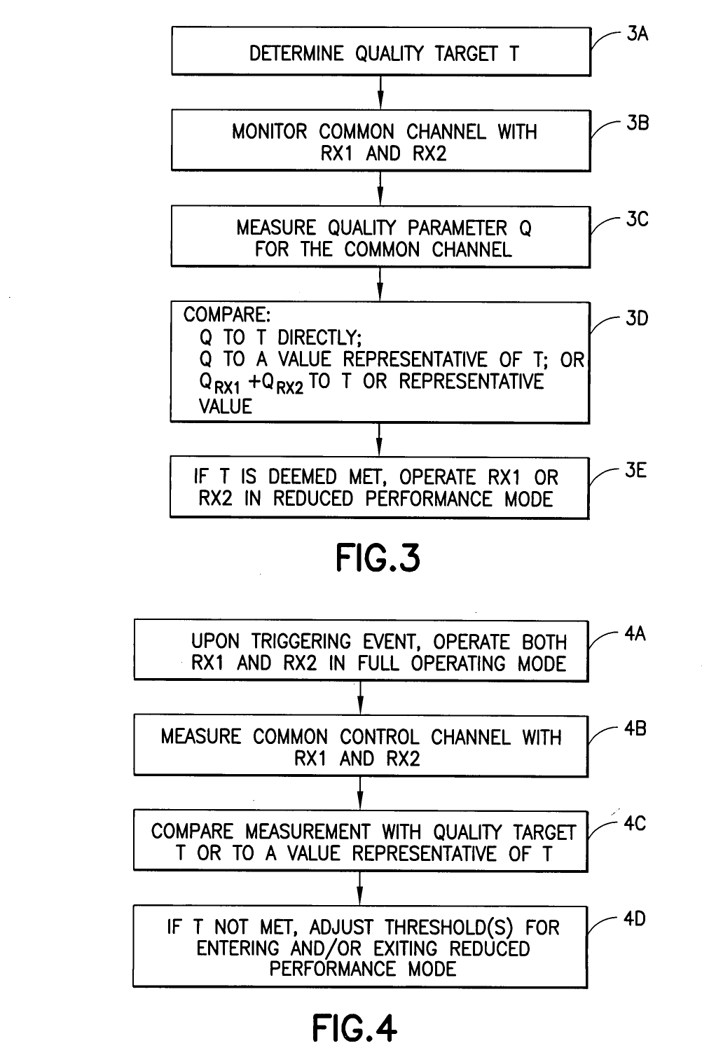

An overview of the process is shown in FIG. 3. A quality target T is determined at 3A, such as by network signaling or recalling the quality target from memory. Both the first and second receivers (RX1 and RX2) monitor the channel at 3B. They measure a quality parameter Q of the channel at 3C. A comparison is made at 3D between the quality target T and the measured parameter Q, either directly if the same type, or against a value representative of the quality target if they are not the same type. In an embodiment, the contribution to total reception quality from each receiver RX1 and RX2 is independently determined, as detailed below for reasons given there. If at step 3E the quality target T is deemed from the comparison to be met, then one of the receivers may be operated in the reduced performance mode. There may be different extents of reduced performance, ranging from one finger being deactivated to an entire receiver being depowered, and the extent of the disparity seen in the comparing at 3D can be used to determine the extent of the reduced performance for that receiver.

First is described an embodiment where the measured quality parameter is directly compared against a threshold. The current receiver quality measurement, Q, could simply be compared to an absolute threshold. The threshold is adapted by the UE 10 in a similar way to how target SIR is adapted by outer loop power control when receiving a dedicated channel. It is shown below that the UE 10 may measure both Q for comparison against the threshold and the parameter used for the target threshold (where they differ) in order to adapt the threshold.

Hysteresis can be used, with separate thresholds for entering and leaving reduced performance mode to avoid too frequent switching between the modes.

A decision is made whether or not the UE 10 should be in a reduced performance mode. In the context of the description below, the measured quality Q may be understood to be the total received signal quality estimate measured using all receiver resources (for example, with both receiver branches in the case of receiver diversity), or may be an estimate of the quality in reduced mode, measured using the reduced receiver resources (for example, using only a single receiver branch in a case of receiver diversity). For example, using different thresholds for entering and leaving the reduced performance modes:
If Q>Q_{reduced}_{_{—}}_{performance}_{_{—}}ₑₙₜₑᵣ, then enter reduced performance mode.
If Q<Q_{reduced}_{_{—}}_{performance}_{_{—}}ₑₓᵢₜ, then enable full receiver hardware.

Then the thresholds are adapted based on the UE's other measurement of the parameter given by the target quality.
If Actual BLER>Signaled BLER target and UE has full receiver hardware enabled then increase Q_{reduced}_{_{—}}_{performance}_{_{—}}ₑₙₜₑᵣ, Q_{reduced}_{_{—}}_{performance}_{_{—}}ₑₓᵢₜ.
If Actual BLER<Signaled BLER target and UE is in reduced performance mode then decrease Q_{reduced}_{_{—}}_{performance}_{_{—}}ₑₙₜₑᵣ, Q_{reduced}_{_{—}}_{performance}_{_{—}}ₑₓᵢₜ.

In another embodiment, the UE 10 measures a quality parameter on each UE receiver branch independently (provided both branches/receivers are powered on). These are denoted Q_{RX1} and Q_{RX2}, which refer to the measured quality parameter at a particular receiver 34, 40 regardless of whether either or both of them is coupled to one or more antennas 20a, 20b. The UE then compares Q_{RX1} and Q_{RX2}. If most of the useful receive signal is on only one antenna then this indicates that the performance benefit of using dual receivers is small at that moment in time. Thus:
If Q_{RX1}<Q_{RX2}−K₁ then enter reduced performance mode with receiver 1 switched off.
If Q_{RX2}<Q_{RX1}−K₂ then enter reduced performance mode with receiver 2 switched off.

In the above, K₁ and K₂ are constants which control how aggressively the UE attempts to save power. If only a small contribution of the overall Q comes from a particular receiver branch then it can be switched off relatively safely. The K factors for the two paths could be different to introduce a bias towards one path if it was known a-priori as likely to be of better reception quality. Constant K₁ and K₂ can also be adapted using the signaled BLER target in a similar way to the thresholds adapted as detailed above. If the actual UE performance is considerably better than the signaled quality target, then K can be reduced to make the switching algorithm more aggressive. If the actual performance is worse than the signaled quality target then K is increased to make the algorithm less aggressive.

Generalized process steps for adapting the thresholds are seen at FIG. 4. At 4A, some triggering event causes both first and second receivers to operate in the full operating mode. Exemplary triggering events include an elapsed time since entering a reduced performance mode, historic information of channel fading conditions/coherence interval, or some other measurable value indicative of a reduced confidence that the target quality is still being met while one of the receivers was in the reduced performance mode (prior to 4A). The fully operating first and second receivers then are used to measure the channel at 4B. This may be simultaneous with measuring the quality parameter from FIG. 3, such as where the quality parameter of FIG. 3 is an instantaneous or generally shorter term measure (SIR) but the quality target is an average over generally a longer period of time (BLER). The measurement in FIG. 4 is for a direct comparison to the quality target, so as to assess the accuracy of any value used in FIG. 3 that was representative of that quality target. At 4C the measurement is compared to the quality target, and this is a direct comparison due to the considerations noted for 4B. If the quality target T is not met by the comparison of 4C, then at 4D the thresholds (representative values of T) used in FIG. 3 are adjusted appropriately, higher for entering the reduced performance mode, and in some instances also lower for exiting the reduced performance mode. Adapting these thresholds is detailed below.

Having decided to switch one of the receivers off, the UE 10 also is described an algorithm to decide to switch it back on again. This is a more difficult problem because once a particular path has been switched off, the UE no longer has actual knowledge of the quality metric Q_{RX1} or Q_{RX2} for that path and therefore cannot determine if it has started to make a useful contribution to the overall quality (in fact, the combined quality is not known anymore). This is the cause of step 4A, which could be triggered in at least two possible ways, either as separate methods or in conjunction. Historic information can be used as a basis for switching the 2^{nd} receiver back on, meaning that if the quality of the remaining path becomes significantly poorer than it was historically then both receivers are re-enabled. Alternatively, both receivers could just be switched back on periodically for a brief period to see if conditions have changed. The decision to re-enable a receiver from reduced performance to full operational mode for the purpose of taking measurements with both receivers could be scheduled or based on quality of the receiver that remains in the full operational mode (an actual quality measurement). In case of scheduled measurements the quality of the first/full mode branch could still be used as an additional “emergency” trigger for re-enabling the second/reduced mode receiver especially if the measurement interval is rather long (e.g. when the signaled quality target is hardly met or not met at all). Since some quality measurements can be made quite rapidly (e.g., from impulse response measurements), switching both receivers to full operating mode might only be needed for a brief period to verify that the other path/receiver isn't offering improved performance compared to the one which has been in use.

The above embodiments may represent distinct and separate approaches. Alternatively, they may be combined to yield a singular device, method, and embodied computer program product that takes some aspects of both embodiments described above, or that uses different of the various aspects under different circumstances of the measured parameter and received data rate.

Based on the foregoing it should be apparent that the exemplary embodiments of this invention provide a method, apparatus and computer program product(s) to operate a user equipment by monitoring a channel with a first and a second receiver of the same UE, where the channel is a common channel preferably a common control channel. A target quality is determined for that channel, which may be signaled to the UE or pre-stored in its memory. The UE then determines/measures a quality parameter for the channel, and compares the measured quality to the target quality. As seen above, the comparison may be between the measured quality parameter and a value representative of the quality parameter. Various embodiments to implement this comparison are shown, such as an absolute threshold, a comparative contribution of each receiver, etc. Responsive to the comparing, one of the receivers is then operated in a reduced performance mode, for which several examples are disclosed. The subject receiver may be switched from full operating mode to reduced performance, or from reduced performance mode to full, and in an implementation the comparison for switching in one direction uses a different threshold than the comparison for switching in the other direction. Embodiments further enable the dynamic adjusting of those thresholds based on measured conditions in the channel that more directly relate the threshold to the target quality. In some embodiments, when switching from reduced performance to full operating mode, the receiver in the reduced performance mode may be temporarily switched to full performance mode in order to take the measurement of quality parameter, and if the comparison is not favorable, that receiver may remain in the full operating mode. In an embodiment, the quality target and measured quality are for a common control channel with which a traffic channel is associated or otherwise mapped.

Further, the exemplary embodiments of this invention provide a method, apparatus and computer program product(s) to operate a network node, such as a BS or RNC, so as to signal/send to a UE a target quality that the UE is to maintain for a common channel. In an embodiment, this quality target relates to a common control channel with which a traffic channel is associated or otherwise mapped.

Another exemplary embodiment provides a method, apparatus and computer program product(s) to operate a UE to dynamically adjust a threshold, where the threshold is for switching a receiver between a full and a reduced operating mode. A common control channel is measured by both first and second receivers of the UE. That measurement is directly compared to a quality target. If the quality target is not met, then the threshold is adjusted. In an embodiment, the threshold and the quality target are of different types, the former being an instantaneous value and the latter being an average.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, or as signaling formats, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well-established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the exemplary embodiments of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not limitations thereof.

We claim:

1. A method comprising:
monitoring a common channel with a first receiver and a second receiver;
determining a target quality for the common control channel;
measuring from the first and second receivers a quality parameter for the common control channel;
comparing the measured quality parameter to the target quality; and
responsive to the comparing, switching the first or second receiver to a reduced performance mode of operation.

2. The method of claim 1, wherein the common control channel comprises a common control channel with which a traffic channel is associated.

3. The method of claim 2, wherein the traffic channel is a multimedia broadcast and multicast service traffic channel.

4. The method of claim 1, wherein the target quality is wirelessly received from a network.

5. The method of claim 1, wherein the target quality is a first type, the measured quality parameter is a second type different from the first type, and comparing the measured quality parameter to the target quality comprises an indirect comparison whereby the measured quality parameter is compared to a threshold value representative of the target quality.

6. The method of claim 5, wherein the first type comprises an average error rate for blocks or packets and the second type comprises a signal to interference measurement.

7. The method of claim 5 executed by a mobile station, further comprising the mobile station dynamically adjusting the threshold autonomous of a network.

8. The method of claim 1, wherein measuring the quality parameter for the common control channel comprises determining a comparative contribution of each of the first and the second receivers to the measured quality parameter.

9. The method of claim 1, further comprising switching the first or the second receiver from the reduced performance mode back to a full operating mode using a different comparison.

10. The method of claim 1, further comprising switching the first or second receiver from the reduced performance mode to a full operating mode temporarily and measuring again the quality parameter for the common control channel.

11. The method of claim 1, further comprising switching the first or second receiver from the reduced performance mode back to a full operating mode responsive to comparing the quality parameter on the common control channel measured with the first receiver to historical channel quality information.

12. An apparatus comprising:
a first receiver adapted to monitor a common channel;
a second receiver adapted to monitor the common control channel;
a processor adapted to measure a quality parameter for the common control channel via the first and second receivers, and to compare the measured quality parameter to a target quality for the common control channel, and responsive to the comparing, the second receiver is adapted to switch to a reduced performance mode of operation.

13. The apparatus of claim 12, wherein the common control channel comprises a common control channel with which a traffic channel is associated.

14. The apparatus of claim 13, wherein the traffic channel is a multimedia broadcast/multicast service traffic channel.

15. The apparatus of claim 12, wherein the target quality is wirelessly received from a network at one of the first and second receivers.

16. The apparatus of claim 12, wherein the target quality is a first type, the measured quality parameter is a second type different from the first type, and the processor is adapted to indirectly compare the measured quality parameter to the target quality by comparing the measured quality parameter to a threshold value representative of the target quality.

17. The apparatus of claim 16, wherein the first type comprises an average error rate for blocks or packets and the second type comprises a signal to interference measurement.

18. The apparatus of claim 16, wherein the apparatus comprises a mobile station and the processor is further adapted to dynamically adjust the threshold autonomous of a network.

19. The apparatus of claim 12, wherein the processor is adapted to determine a comparative contribution of each of the first and the second receivers to the measured quality parameter.

20. The apparatus of claim 12, further wherein the processor is adapted to switch the second receiver from the reduced performance mode back to a full operating mode using a different comparison.

21. The apparatus of claim 12, wherein the first or the second receiver is adapted to temporarily switch from the reduced performance mode to a full operating mode and to measure again with the first and the second receivers the quality parameter for the common control channel.

22. The apparatus of claim 12, wherein the first or the second receiver is adapted to switch from the reduced performance mode back to a full operating mode responsive to the processor comparing the quality parameter on the common control channel measured with the first and the second receivers to historical channel quality information.

23. A computer readable memory embodying a program of machine-readable instructions executable by a digital data processor to perform actions directed toward switching a receiver to a reduced performance mode of operation, the actions comprising:
monitoring a common channel with a first receiver and a second receiver;
determining a target quality for the common control channel;
measuring from the first and second receivers a quality parameter for the common control channel;
comparing the measured quality parameter to the target quality; and
responsive to the comparing, switching the second receiver to a reduced performance mode of operation.

24. The memory of claim 23, wherein the common control channel comprises a common control channel with which a multimedia broadcast and multicast service traffic channel is associated.

25. The memory of claim 23, wherein the target quality is wirelessly received from a network.

26. The memory of claim 23, wherein the target quality comprises an average error rate for blocks or packets, the measured quality parameter comprises signal to interference measurement, and comparing the measured quality parameter to the target quality comprises an indirect comparison whereby the bit measurement is compared to a threshold value representative of the average error rate.

27. The memory of claim 26, wherein the memory and processor are disposed within a mobile station, and the instructions further comprise dynamically adjusting the threshold autonomous of a network.

28. The memory of claim 23, wherein measuring the quality parameter for the common control channel comprises determining a comparative contribution of each of the first and the second receivers to the measured quality parameter.

29. The memory of claim 2, the actions further comprising switching the first or the second receiver from the reduced performance mode back to a full operating mode responsive to comparing the quality parameter on the common control channel measured with the first and the second receiver to historical channel quality information.

30. An apparatus comprising:
first and second receiving means for receiving a common control channel;
measuring means for determining from the first and second receiving means a quality parameter for the common control channel; and
comparing means for comparing the measured quality parameter to a target quality for the common control channel;
wherein the second receiving means is responsive to the comparing means to switch to a reduced performance mode of operation.

31. The apparatus of claim 30, wherein;
the first and second receiving means comprise respective first and second wireless receivers and a multimedia broadcast and multicast service traffic channel is associated with the common control channel; and
the measuring means and the comparing means comprises a processor coupled to a memory.
